(19) United States
(12) Patent Application Publication
(10) Pub. No.: US 2024/0055692 A1
(43) Pub. Date: Feb. 15, 2024

(54) BATTERY COMPRISING A CASING AND AN ELECTRICALLY INSULATING COATING

(71) Applicant: Volkswagen Aktiengesellschaft, Wolfsburg (DE)

(72) Inventor: Lukas KWOCZEK, Braunschweig (DE)

(73) Assignee: Volkswagen Aktiengesellschaft, Wolfsburg (DE)

(21) Appl. No.: 18/234,251

(22) Filed: Aug. 15, 2023

(30) Foreign Application Priority Data
Aug. 15, 2022 (DE) 10 2022 120 549.5

(51) Int. Cl. H01M 10/653; H01M 50/169

(52) U.S. Cl. CPC H01M 10/653; H01M 50/169

(57) ABSTRACT

A battery comprises a battery element or multiple battery elements accommodated in a casing and an electrically insulating coating for the casing. The coating is formed of at least one film material. The at least one film material overlaps on at least one seam of the coating. The at least one overlapping film material is welded on at least one seam in order to achieve the best possible sealing coating.

This nonprovisional application claims priority under 35 U.S.C. § 119(a) to German Patent Application No. 10 2022 120 549.5, which was filed in Germany on Aug. 15, 2022, and which is herein incorporated by reference.

### BACKGROUND OF THE INVENTION

### Field of the Invention

The present invention relates to a battery comprising one or more battery elements accommodated in a casing and comprising an electrically insulating coating for the casing, wherein the coating is formed from at least one film material, wherein the at least one film material overlaps on at least one seam.

### Description of the Background Art

A battery is a storage device for electrical energy on an electrochemical basis, the discharge of which converts stored chemical energy into electrical energy by an electrochemical redox reaction. In the context of the invention, batteries are understood to be both so-called primary batteries, which are intended only for a single discharge and not for recharging, and so-called secondary batteries or rechargeable batteries, which are intended for multiple charging and discharging and are designed accordingly. Charging a secondary battery represents the electrolytic reversal of the electrochemical redox reaction that takes place during discharge, which is realized by applying an electrical voltage.

A battery comprises one or, usually, multiple battery elements arranged within a coating, usually in the form of a film coating or casing, often referred to as a “pouch”. The battery elements each comprise two electrodes, a separator arranged between the electrodes for electrical separation of the electrodes and an electrolyte serving as an ion conductor. The two electrodes of a battery element differ in terms of an included active material, whereby one of the electrodes is anodic and the other cathodic (in each case related to a discharge of the battery cell). Furthermore, a battery usually comprises two battery terminals, which are integrated into the coating, and which are electrically conductively connected to the electrodes on the inside of the coating via so-called current arrestors. All anodic electrodes are connected to one of the battery terminals and the cathodic electrodes to the other battery terminal.

Designing a battery with a casing can have the advantage that the battery has a higher structural load capacity as compared to batteries with a film coating. Frequently, a battery casing is made of a metal, especially aluminum, in order to achieve sufficiently high structural strength and thus load-bearing capacity while at the same time being good and cost-effective in manufacturability and relatively low weight. However, since such a casing itself is electrically conductive, it may be useful or necessary to electrically insulate it from the environment, for which the casing can also be provided with an electrically insulating coating.

Such a battery is known from JP 2002-184364 A, wherein the film material of the coating has a thermally activatable adhesive for bonding the coating in the area of the seam, at least in the area of one seam. The adhesive can be activated by means of a hot pressing tool that is pressed against the seam.

CN 211 764 018 U and US 2012/0219847 A1 each disclose a battery with a film coating, also known as a pouch.

### SUMMARY OF THE INVENTION

It is therefore an object of the present invention to provide a battery comprising a casing as well as comprising an electrically insulating coating surrounding the casing.

According to an exemplary embodiment of the invention, a battery, in particular a lithium-ion battery and/or a battery intended as a traction battery of a motor vehicle, is provided. The battery comprises at least one battery element, preferably multiple battery elements, and a casing (completely) surrounding the battery element or elements.

The at least one battery element can comprise two electrodes (each), a separator arranged between the electrodes for the electrical separation of the electrodes and an electrolyte serving as an ion conductor between the electrodes. This electrolyte can be liquid or solid and, especially in the case of a solid structure, can also act as a separator. A battery according to the invention may further comprise a first battery terminal and a second battery terminal, wherein the battery terminals are provided for the electrical connection of the battery to an external circuit. For this purpose, the battery terminals can be integrated into the casing in such a way that a first section of them is located outside the casing and is thus accessible for connection to the external circuit, while a second section inside the coating serves as an electrical connection to the battery elements. A first electrode of the battery element(s) is electrically connected to the first battery terminal and a second electrode of the battery element(s) is electrically connected to the second battery terminal.

The casing can be designed to be dimensionally stable. A casing can be considered to be “dimensionally stable” if its three-dimensional shape does not collapse as a result of its own weight without external load. Preferably, such a casing can be designed to be dimensionally stable in such a way that it does not collapse and, preferably, is not deformed to a relevant extent when exposed to external forces that occur during normal use. Furthermore, the casing can preferably be made entirely or partially of metal, for example aluminum. Furthermore, preferably, the casing can be designed in such a way that it is gas-tight, which can have a positive effect on the performance and operational reliability of the battery.

A battery according to the invention or to be manufactured according to the invention further comprises an electrically insulating coating for the casing, wherein the sheath may completely surround the casing. The coating is made of at least one film material, with the at least one film material overlapping on at least one seam. The coating can preferably be formed at least partially by coating the casing with the at least one film material. The film material can preferably have plastic or be made of plastic, which means that an electrically insulating coating can be designed cost-effectively and easily processable. The film material can preferably also contain metal, for example aluminum, which can improve the load-bearing capacity and especially the tear resistance of the film material. It may be particularly preferable that the film material comprises at least one layer of plastic and at least one layer of metal. In particular, it may be provided that at least two layers of plastic are provided, with one layer of metal, if provided, being placed between the two layers of plastic.

At least one overlapping film material is or will be welded on at least one seam. As a result, a fluid-tight design of the seam can be realized relatively easily and safely, whereby it can be avoided that a liquid medium in particular, especially due to a capillary effect, reaches the casing via the seam and can thus cause corrosion of the casing. Accordingly, it may preferably be provided that all seams of the coating, which are formed by overlapping at least one film material, are welded accordingly.

According to the invention, welding (welding together) can be generally understood to mean the inseparable joining of one or more materials by applying heat and/or pressure, with or without welding consumables, wherein at least one of the materials is melted, wherein a cohesive connection is effected when the melt solidifies. According to the invention, fusion welding of the at least one film material on the at least one seam is preferably provided, so that for welding at least one material of the film material itself in the area of the seam is caused to melt.

The coating can be bonded to the casing. For this purpose, the at least one film material may preferably already have an adhesive layer in its initial state, i.e., before it is connected to the casing to form the coating. In particular, the adhesive layer can already be part of the film material in a delivery condition, so that the adhesive no longer has to be applied as part of the production of the battery. By gluing the coating to the casing, it can be realized that it lies as fully as possible on the casing. Also, such gluing of the coating to the casing can simplify the application of the coating itself. In addition, such gluing of the coating to the casing can largely prevent the penetration of a particularly liquid medium into the area between the coating and the casing and thus have a sealing effect. However, it has been shown that a sufficiently secure seal, at least in the area of the sat least one seam of the coating in which at least one of the film materials overlaps, cannot always be ensured by the gluing, so that according to the invention the (additional) welding of the film material is provided in the area of the seam.

Welding can preferably be effected by means of a hot welding tool that contacts the seam. This provides an easy way to apply heat to the seam to melt at least one of the materials of the film material, while applying sufficient pressure to fix the overlap of at least one of the film materials until the melt hardens. Preferably, it can be provided that the at least one film material in the area of the seam is pressed against the casing by means of the welding tool.

The welding tool may preferably have a contact surface intended for contact with the seam of the coating, wherein the contact surface has a non-stick effect. Accordingly, the contact surface is designed in such a way that any material of the at least one film material that may still be molten does not essentially adhere to the contact surface. For this purpose, the contact surface of the welding tool can, for example, be made of a corresponding material, such as PTFE.

The at least one film material can be formed of the same material, preferably a plastic, at the contact surfaces lying in the seam (contacting each other), whereby an advantageous joining of the at least one film material can be realized by in particular fusion welding of this material.

Furthermore, it may be provided that the at least one film material or at least one, possibly several or all of several film materials is made entirely of a single material or at least of a single plastic (and possibly one or more other materials, e.g., metal(s)). As a result, the most cost-effective design of the coating can be realized.

At least one film material or at least one, possibly several or all of several film materials can be made of at least two different materials, preferably at least two different plastics. The different materials can preferably be present in separate, but preferably interconnected layers of the film material. As a result, a more resilient and/or processable film material can be obtained.

The at least one film material can have, at least on the seam, a first layer of a first of the materials on the inside (i.e., closer to the casing) and a second layer of a second of the materials on the outside (i.e., on the side of the first layer facing away from the casing), wherein the first material has a lower melting temperature than the second material. This makes it possible in an advantageous way to melt the first material for welding the seam, while the second material is not melted and can thus ensure the integrity of the film material. If the second material is not melted, an unwanted connection with and thus adhesion to the welding tool can also be avoided. In such a case in particular, it may be possible to dispense with designing the welding tool with a non-stick effect of the contact surface. If different film materials overlap at the seam, this design or arrangement of the different materials applies at least and, preferably, exclusively to the film materials located in the outer overlapping.

The casing of a battery may have a cuboid shape. A cuboid casing has a length, width and height, wherein according to the invention the length is the largest, the width is the middle and the height is the smallest of the (edge) dimensions (if there are corresponding differences). A cuboid battery coating comprises two large sides that are stretched by the length and the width, two long sides that are stretched by the length and the height, and two end sides, which are stretched by the width and the height. Battery terminals of the battery can preferably be integrated into one or both of the end faces.

In such a battery with a cuboid casing, the coating may include a first coating part on the large sides and the long sides of the casing and a second coating part on each of the end faces, wherein, further preferably, the first coating part and the second coating part may be formed of different film materials. In addition, it may be provided that the first coating part also partially or completely covers the end faces of the casing and that the second coating parts overlap the sections of the first coating part there in order to form one or more seams each. It may particularly be provided that the second coating parts are each made of a film material comprising at least two materials. The first coating part, especially if it does not form a seam itself, may preferably be made of a film material comprising only a single material or at least only a single plastic. If, on the other hand, the first coating part itself forms at least one seam, it may preferably be made of a film material comprising at least two materials and, in particular, be of the same film material as the second coating parts.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows cuttings of film materials for the formation of a coating for a casing of a battery according to the invention;

FIG. 2 shows fixing the film materials to the casing of the battery to form the coating;

FIG. 3 shows a section of the battery after the formation of the coating;

FIGS. 4 to 6 show various method steps for welding seams of the coating in the area of a front end of a battery according to the invention according to a first embodiment of the invention;

FIGS. 7 to 9 show various method steps for welding seams of the coating in the area of a front end of a battery according to the invention according to a second embodiment of the invention; and

FIG. 10 shows a longitudinal representation of a battery according to the invention (still without coating).

### DETAILED DESCRIPTION

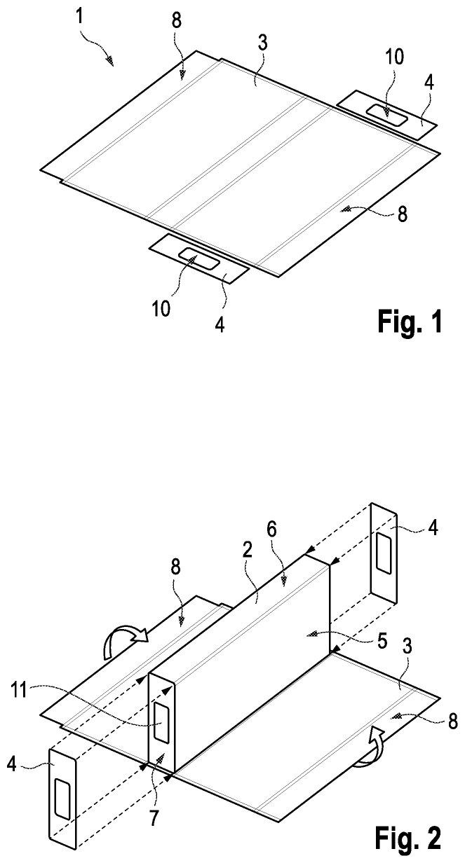

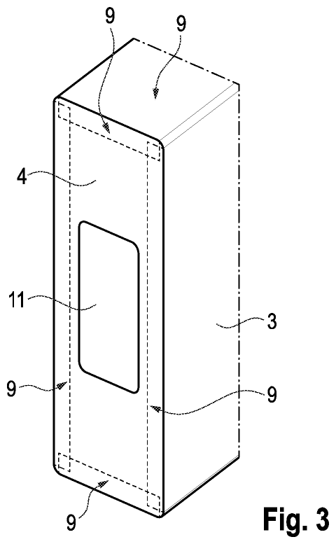

FIG. 1 shows cuttings made of one or more film materials for the formation of a coating 1 for a casing 2 of a battery according to the invention. A first cutting is provided for the formation of a first coating part 3. As part of the production of the battery, this is wrapped around the casing 2 (see FIG. 2) in such a way that it surrounds or covers the large sides 5 and the long sides 6 of the casing 2. End sections 8 of the first coating part 3 overlap each other and thus form a seam 9, which is arranged in the area of one of the long sides 6 of the casing 2 (cf. FIG. 3). The cut for the first part of the coating 3 is dimensioned in such a way that it also partially covers the end faces 7 of the casing 2, specifically a section along each of the edges of the end faces 7 (cf. FIG. 3).

Two further cuts each form a second coating part 4, wherein these second coating parts 4 are each provided to cover one of the end faces 7 of the casing 2. In a central section, the second coating parts 4 each have a rectangular cut-out 10, through which a battery terminal 11 of the battery can extend in each case. The circumferential shape of the second coating parts 4 is adapted as precisely as possible to those of the end faces 7 of the casing 2. The second coating parts 4, which are attached to the casing 2 only after the first coating part 3, thus overlap the sections of the first coating part 3 present at the end faces 7 and thus also form seams 9.

The coating parts 3, 4 may be provided with an adhesive layer on the inside, i.e., on those sides which are intended for contact with the casing 2, so that adhesive bonds are formed between these components immediately upon the attachment of the coating parts 3, 4 to the casing 2.

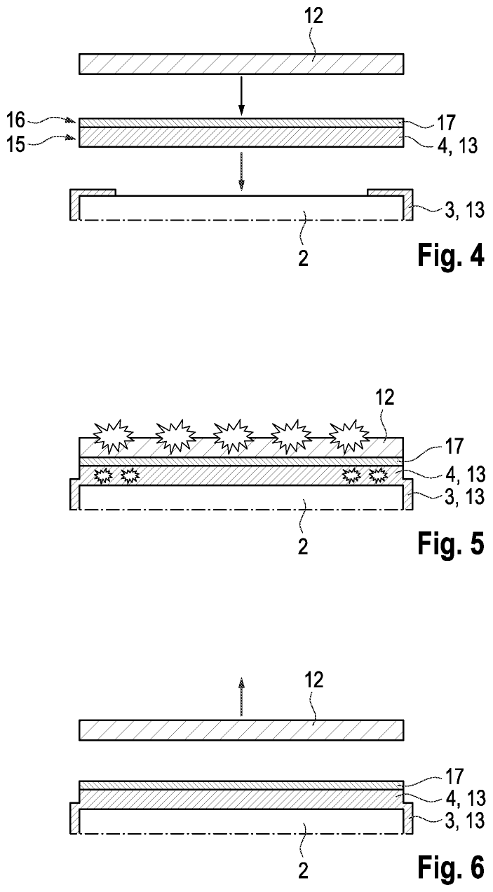

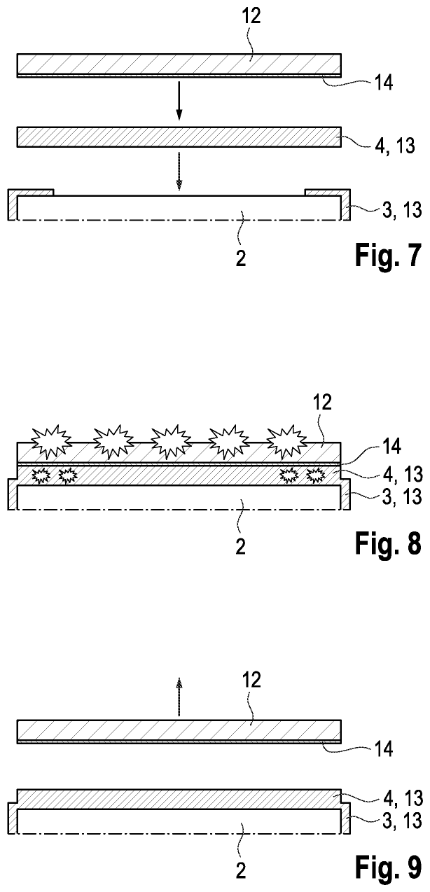

In order to form a coating 1 that is as well sealed as possible, it is provided according to the invention to weld the overlaps of the coating parts 3, 4 on all of the seams 9. A corresponding procedure is described in FIGS. 4 to 6 and 7 to 9 for welding the seams 9 of a battery according to the invention, for example, a battery according to 2 and 3, formed between the first coating part 3 and a second coating part 4. FIGS. 4 to 6 on the one hand and FIGS. 7 to 9, on the other hand show different embodiments of the second coating parts 4 and, consequently, the use of different welding tools 12.

According to both embodiments, it is provided to realize a welding of the coating parts 3, 4 or the film material or the film materials from which the coating parts 3, 4 are formed. For this purpose, a hot welding tool 12, which is preferably electrically heated by having heating elements (not shown) integrated into it, is pressed onto the respective second coating part 4, which is already attached to the casing 2. Due to a transfer of thermal energy from the welding tool 12 to the materials of the film material or the film materials of the coating parts 3, 4, these are at least partially temporarily melted (cf. FIGS. 5 and 8). After removal of the welding tool 12 and sufficient cooling of the melt, which leads to solidification of the melt, a corresponding cohesive (welding) connection is formed between the coating parts 3, 4 (cf. FIGS. 6 and 9).

The welding tool 12 may preferably be designed in such a way that it contacts the second coating part 4 only in the area of the seams 9. For this purpose, this can, for example, have the shape of a rectangular frame. It may also be provided that the welding tool 12 contacts the second coating part 4 in a larger section in each case, if necessary over the entire surface, but is only at the appropriate temperature in the area of the seam points 9. In addition, it may be provided that the entire welding tool 12 contacts the second coating part 4 in a larger section, if necessary over the entire surface, and is also tempered over the entire surface.

According to both embodiments, the film material of the first coating part 3 is formed entirely or at least fully circumferentially of a first, electrically insulating and weldable plastic 13. Optionally, an additional layer (not shown) of, for example, a metal may be provided, which is completely or fully circumferentially embedded in the first plastic 13.

In the embodiment according to FIGS. 7 to 9, the first coating part 3 and the second coating part 4 are made of the same film material or of different film materials, which, however, do not differ in terms of material technology or material, but only in terms of material strength, for example, so that an advantageous weldability of the seams 9 of the coating 1 can be realized by means of identical material pairings. Since the plastic from which all of the coating parts 3, 4 are at least formed fully circumferentially is designed to melt due to the transfer of thermal energy from the welding tool 12, it is provided that the welding tool 12 has a contact surface with a non-stick effect, which can be realized by a corresponding coating 14 made of, for example, PTFE. This prevents the melted and possibly already (partially) resolidified (first) plastic 13 from adhering too strongly to the welding tool 12, which could otherwise lead to damage to the coating 12 when the welding tool 12 (cf. FIG. 9) is removed.

In the embodiment according to FIGS. 4 to 6, the second coating parts 4 on the one hand and the first coating part 3 on the other hand is formed of film materials that are also different in terms of material technology. The film material of the second coating part 4 has a first, inner layer 15 of the same (first) plastic 13 from which the film material of the first coating part 3 is at least fully circumferentially formed. In addition, the film material of the second coating 4 has a second, external layer 16 of a second material 17, which can preferably also be an electrically insulating plastic. However, the second material 17 has a higher melting temperature as compared to the (first) plastic 13 of the first layer 15. The melting temperature of this second material 17 is so high that it is not reached by the transfer of thermal energy from the welding tool 12, at least not within a defined period of time intended for pressing the welding tool 12 to the second coating parts 4. As a result, even without a coating of the welding tool 12 to achieve a non-stick effect, excessive adhesion of the welding tool 12 to the second coating parts 4 can be prevented. As a result, the welding tool 12 can be designed in a simplified way.

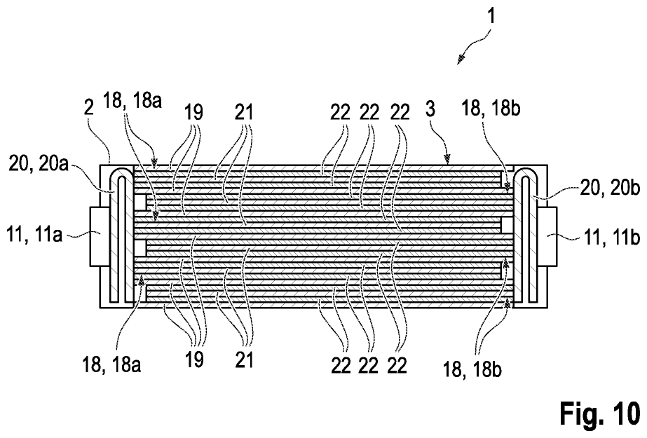

According to FIG. 10, the battery can comprise multiple battery elements arranged within the casing 2. The battery elements or the components that form them can be present in the form of a battery element stack. The battery element stack then comprises, in alternating order, plate-shaped electrodes 18 and electrically insulating, plate-shaped separators 19. The electrodes 18 are again alternately present in the battery element stack as first electrodes 18a, which act as anodes when the battery is discharged, and as second electrodes 18b, which act as cathodes when the battery is discharged. At the same time, the separators 19 can also be a solid electrolyte of the battery elements. Alternatively, a liquid electrolyte in particular may be arranged within the casing 2 with which the separators 19 are impregnated. The plate-shaped electrodes 18 and separators 19 have a (very flat) cuboid shape, which, in conjunction with the stacking, also results in a cuboid shape of the battery element stack.

The battery elements may further comprise current arresters 20, each of which is electrically conductively connected to one of the electrodes 18, wherein the first current arrester 20a belongs to the first electrodes 18a and second current arresters 20b belong to the second electrodes 18b. All first current arresters 20a are located on a first end face and all second current arresters 20b are located on a second end face of the battery element stack. This allows for an advantageous connection of the various (first and second) current arresters 20 with each of the battery terminals 11 integrated into the casing 2.

The battery terminals 11 are integrated into one of the end faces 7 of the casing 2 in such a way that a section thereof within the casing 2 is available for connection to the current arresters 20 of the respective assigned electrodes 18. All first current arresters 20a are connected to a first (11a) of the battery terminals 11 and all second current arresters 20a to a second (11b) of the battery terminals 11. A further section of the battery terminals 11, each of which is located outside the casing 2, is provided for external electrical contacting of the battery.

The current arresters 20 may be integrally designed with the electrodes 18 in that a flat substrate 21 of an electrically conductive material, such as a metal film, is coated on both sides with an anodic or cathodic active material 22 in a section that is part of the electrode 18, while an uncoated section of the substrate 21 represents the current arrester 20 belonging to the respective electrode 18.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery comprising:
a casing;
one or more battery elements accommodated in the casing; and
an electrically insulating coating for the casing, the coating being made of at least one film material that overlaps on at least one seam, the at least one overlapping film material being welded on at least one seam.

2. The battery according to claim 1, wherein the coating is glued to the casing.

3. The battery according to claim 1, wherein the at least one film material is formed of the same material at least on the contact surfaces located in the seam.

4. The battery according to claim 1, wherein the at least one film material or at least one of multiple film materials is completely formed from a single material.

5. The battery according to claim 1, wherein the at least one film material or at least one of multiple film materials is formed from at least two materials.

6. The battery according to claim 5, wherein the film material has a first, inner layer of a first of the materials and a second, outer layer of a second of the materials, and wherein the first material has a lower melting temperature than the second material.

7. The battery according to claim 1, wherein the casing has a cuboid shape, wherein the coating is formed on the large sides and the long sides of the casing of a first coating part and on the end faces of a second coating part, and wherein the first coating part and the second coating part is formed of different film materials.

8. A method for manufacturing a battery, the method comprising:
providing one or more battery elements accommodated in a casing;
providing an electrically insulating coating for the casing;
forming the coating from at least one film material;
overlapping the at least one film material on at least one seam; and
welding the at least one overlapping film material on the at least one seam.

9. The method according to claim 8, wherein the welding is performed via a hot welding tool contacting the seam.

10. The method according to claim 9, wherein the welding tool contacts the seam with a contact surface having a non-stick effect.
